(19) United States
(12) Patent Application Publication
(10) Pub. No.: US 2018/0213267 A1
(43) Pub. Date: Jul. 26, 2018

(54) DISTRIBUTED SURVEILLANCE

(71) Applicant: The Khoshbin Company, Irvine, CA (US)

(72) Inventor: Manuchehr Khoshbin, Irvine, CA (US)

(21) Appl. No.: 15/745,711

(22) PCT Filed: Jul. 26, 2016
(86) PCT No.: PCT/US16/44050

§ 371 Date: Jan. 17, 2018

Related U.S. Application Data
(60) Provisional application No. 62/199,815, filed on Jul. 31, 2015.

(51) Int. Cl. H04N 21/239; H04N 21/2187; H04N 21/41; H04N 7/18

(52) U.S. Cl. CPC H04N 21/2393; H04N 7/183; H04N 21/4126; H04N 21/2187

(57) ABSTRACT

Machine implemented methods of requesting multimedia from users having multimedia capture devices. A requester transmits a request which includes a location and description of an object to be captured. A server computes distances between the location of the object and one or more responders whose locations are within a predetermined area of the location of the object. The server transmits one or more notices to the one or more responders. Upon receiving one or more responses from the one or more responders, the server selects a respondent from the one or more responders and transmits the request to the respondent. The respondent captures the multimedia and streams the multimedia to the server and/or records it on its device for further processing. The server notifies the requester of the availability of the multimedia. The requester views and/or receives the multimedia from the server.

### CROSS-REFERENCE TO RELATED APPLICATIONS

This application claims priority to PCT application PCT/US2016/044050, filed on Jul. 26, 2016. PCT application PCT/US2016/044050 claims priority to U.S. Provisional Patent Application Ser. No. 62/199,815, filed on Jul. 31, 2015.

### BACKGROUND

Many users may wish to receive information related to objects, people, etc. that the users are not able to observe in person.

Smartphones and tablets are ubiquitous in society. Such devices typically include media display and playback features (e.g., a touchscreen, speakers, etc.). In addition, such devices typically include media capture features (e.g., cameras, microphones, etc.). The device are further able to communicate across one or more networks.

Therefore there exists a need for a solution that allows users to request, from another user, media information related to subject matter that is not able to be observed by the requester user.

### SUMMARY

Some embodiments provide ways to request surveillance of various locations, objects, and/or people. A requester may generate a request including a location, type, payment rate, and/or other appropriate parameters.

The request may be analyzed at a server and distributed to a set of potential responders. The set of potential responders may be identified based on various attributes of the responders (e.g., location, type, rating, etc.).

Each potential responder may have an opportunity to apply for the request. The server may generate a list of potential responders based on received applications. The list may be sent to the requester for selection of a particular responder.

The requester may select the particular responder and the particular responder may be notified of the assignment.

The responder may indicate when the responder is available to fulfill the request by capturing media at the specified location. Depending on the availability of the responder and requester, the surveillance may be performed as a real time streaming event. Alternatively, the responder may complete the request and the captured media may be stored and made available to the requester.

The requester may receive the captured media in real time or at a later time depending on the type of request. During a streaming event, the requester and responder may be able to communicate.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a distributed surveillance system according to an exemplary embodiment;

FIG. 2 illustrates a schematic block diagram of an exemplary user device of the system FIG. 1;

FIG. 3 illustrates a flow chart of an exemplary process that provides distributed surveillance;

FIG. 4 illustrates a flow chart of an exemplary client-side process that receives surveillance requests;

FIG. 5 illustrates a flow chart of an exemplary server-side process that receives surveillance requests;

FIG. 6 illustrates a flow chart of an exemplary client-side process that presents surveillance requests to potential responders;

FIG. 7 illustrates a flow chart of an exemplary server-side process that receives responses to surveillance requests from;

FIG. 8 illustrates a flow chart of an exemplary client-side process that receives response selections from requesters;

FIG. 9 illustrates a flow chart of an exemplary client-side process that presents assignments to responders;

FIG. 10 illustrates a flow chart of an exemplary server-side process that receives response selections from requesters and sends assignments to selected responders;

FIG. 11 illustrates a flow chart of an exemplary client-side process that captures and processes media for a responder;

FIG. 12 illustrates a flow chart of an exemplary server-side process that captures and processes media from a responder;

FIG. 13 illustrates a flow chart of an exemplary client-side process that retrieves and presents media to a requester;

FIG. 14 illustrates a flow chart of an exemplary server-side process that retrieves and provides media to a requester;

FIG. 15 illustrates a message flow diagram of an exemplary communication algorithm;

FIG. 16 illustrates an exemplary graphical user interface (GUI) that presents surveillance options to users;

FIG. 17 illustrates an exemplary GUI that presents requests to potential responders using a map-based view;

FIG. 18 illustrates an exemplary GUI that allows responders to search for available requests;

FIG. 19 illustrates an exemplary GUI that presents requests to potential responders using a list-based view;

FIG. 20 illustrates an exemplary GUI that presents a request to a potential responder;

FIG. 21 illustrates an exemplary GUI that generates a request;

FIG. 22 illustrates an exemplary GUI that presents a queue to a requester;

FIG. 23 illustrates an exemplary GUI that provides a list of responders to a requester;

FIG. 24 illustrates an exemplary GUI that provides information regarding a particular responder;

FIG. 25 illustrates an exemplary GUI that provides information regarding a request after a responder has been selected;

FIG. 26 illustrates an exemplary GUI that provides streaming surveillance between a responder and a requester; and

FIG. 27 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a distributed surveillance network. A requester may be able to generate an assignment or task, including a specified rate, a location, and/or other relevant information. The assignment may then be presented to various potential responders. One or more of the potential responders may indicate a desire to accept the assignment. The requester may be able to select from among the actual responders and the task may be assigned to the selected responder. The responder may proceed to fulfill the task request by collecting media (e.g., pictures, video, etc.). The media may then be provided to the requester. Some embodiments may allow real-time streaming of media and two-way communication that allows the requester and responder to interact during capture/streaming of the media content.

In one aspect, a machine implemented method of requesting multimedia is disclosed wherein the method comprises transmitting a request for multimedia, via a requester device, said request comprising a description and location, receiving the request, via a server, transmitting one or more responder notices to one or more responders within a predetermined area of the location, via the server, receiving the one or more responder notices, via one or more responder devices, transmitting one or more responses from the one or more responders, via the one or more responder devices, receiving the one or more responses, via the server, selecting a respondent from the one or more responders, via the server, transmitting the request to the respondent, via the server, receiving the request, via one of the one or more responder devices, and at least one of recording and streaming the multimedia, via the one of the one or more responder devices.

Preferably, the method further comprises receiving the multimedia, via the server, recording the multimedia, via the server, transmitting a requester notice, via the server, and receiving the multimedia, via the requester device.

In another aspect, a machine implemented method of obtaining multimedia is disclosed wherein the method comprises transmitting a request for multimedia, via a requester device, said request comprising a description and location, and receiving the multimedia, via the requester device, wherein the multimedia is captured by a respondent, via a responder device, said respondent is selected from one or more responders within a predetermined area of the location. Preferably, a non-transitory machine-readable storage medium, which provides instructions that, when executed by a processing system, causes the processing system to perform operations according to a method as in this method. Preferably, a method of providing a user interface for obtaining multimedia, the user interface being accessible via the requester device, said method comprising a method as in this method. Preferably, a non-transitory machine-readable storage medium, which provides instructions that, when executed by a processing system, causes the processing system to perform operations according to a method as in this method.

In another aspect, a machine implemented method of requesting multimedia is disclosed wherein the method comprises receiving a request for multimedia, via a server, said request comprising a description and location, transmitting one or more responder notices to one or more responders within a predetermined area of the location, via the server, receiving one or more responses from the one or more responders, via the server, selecting a respondent from the one or more responders, via the server, transmitting the request to the respondent; via the server, receiving the multimedia, via the server, recording the multimedia, via the server, and transmitting a requester notice, via the server. Preferably, a non-transitory machine-readable storage medium, which provides instructions that, when executed by a processing system, causes the processing system to perform operations according to a method as in this method. Preferably, a method of providing a user interface for requesting multimedia, the user interface being accessible via the server, said method comprising a method as in this method. Preferably, a non-transitory machine-readable storage medium, which provides instructions that, when executed by a processing system, causes the processing system to perform operations according to a method as in this method.

In another aspect, a machine implemented method of capturing multimedia is disclosed wherein the method comprises receiving a responder notice, via a device, transmitting a response, via the device, receiving a request for multimedia, via the device, said request comprising a description and location, and at least one of recording and streaming the multimedia, via the device. Preferably, a non-transitory machine-readable storage medium, which provides instructions that, when executed by a processing system, causes the processing system to perform operations according to a method as in this claim. Preferably, a method of providing a user interface for capturing multimedia, the user interface being accessible via the device, said method comprising a method as in this method. Preferably, a non-transitory machine-readable storage medium, which provides instructions that, when executed by a processing system, causes the processing system to perform operations according to a method as in this method.

In another aspect, a computer network system for requesting multimedia is disclosed wherein the system comprises a requester device having a processing unit and program code stored on a storage device of said requester device, said program code to perform a requester method when executed by said processing unit, a server having a processing unit and program code stored on a storage device of said server, said program code to perform a server method when executed by said processing unit, one or more responder devices, each responder device having a processing unit and program code stored on a storage device of said responder device, said program code to perform a responder method when executed by said processing unit, said requester method, comprising transmitting a request for multimedia, said request comprising a description and location, said server method, comprising receiving the request, transmitting one or more responder notices to one or more responders within a predetermined area of the location, receiving one or more responses from the one or more responders, selecting a respondent from the one or more responders, and transmitting the request to the respondent, said responder method, comprising receiving the one or more responder notices, transmitting the one or more responses from the one or more responders, receiving the request, via one of the one or more responder devices, and at least one of recording and streaming the multimedia, via the one of the one or more responder devices.

Preferably, the program code of the server when executed by said processing unit of the server further performs steps of receiving the multimedia, recording the multimedia, and transmitting a requester notice, and wherein the program code of the requester device when executed by said processing unit of the requester device further performs a step of receiving the multimedia. Preferably, the multimedia comprises at least one of text, audio, still images, animation, and video. Preferably, the location comprises a street address, name of city, name of state, and name of country. Preferably, the description is one of a building-description and a person description. Preferably, at least one of the requester device and the one or more responder devices is a smartphone.

A first exemplary embodiment provides a distributed surveillance system including: multiple requester devices, each requester device including at least one media presentation element; multiple responder devices, each responder device including at least one media capture element that is able to capture media content; and a server that is able to communicate among the requester devices and the responder devices.

A second exemplary embodiment provides a method of providing surveillance for a requester. The method includes: receiving a request for surveillance from the requester; publishing the request to at least one responder; receiving at least one acceptance from the at least one responder; sending a list of acceptances to the requester; receiving a selection of a selected responder from among the at least one responder; assigning the request to the selected responder; and receiving multimedia from the selected responder.

A third exemplary embodiment provides a user device that allows surveillance within a distributed system. The user device includes: a processor for executing sets of instructions; and a memory that stores the sets of instructions. The sets of instructions include: generating a surveillance request; sending the surveillance request to a server; receiving at least one response to the surveillance request; receiving a selection of a responder from among a set of responders associated with the at least one response; and receiving, from the selected responder, captured media at the user device.

Several more detailed embodiments are described in the sections below. Section I provides an overview of some embodiments. Section II then describes a hardware architecture of some embodiments. Next, Section III describes various methods of operation used by some embodiments. Section IV then describes various GUIs provided by some embodiments. Lastly, Section V describes a computer system which implements some of the embodiments.

### I. Overview and Examples

On demand multimedia capture may be requested from individuals using the systems and methods described herein. A computer network system, which includes servers and smartphones communicating via the Internet and/or other networks using mobile applications (or “apps”), may be used by some embodiments. A requester may place a request for multimedia with the server which in turn selects a willing individual to capture the multimedia. The requester provides the location and description of the subject matter of the multimedia.

As one example, an individual residing in Irvine, Calif. may use a desktop computer to request someone near a particular building, for instance the John Hancock building in Chicago, Ill., to record a thirty second video of the front side of the building. The request (or “job” or “task”) may be sent to the server which may be in communication with individual responders who use mobile devices, such as smartphones. The server may send push notifications to responders who are within a predetermined area, for instance three miles of the building of such request.

Responders who are willing to perform the task may communicate their responses to the server which in turn may select one respondent (or “responder”) from the responders and provides the request to the respondent. The respondent may have the option of streaming the video to the server or recording it for uploading it to the server at a later time. The server may record the video and notify the requester of the availability of the video by sending a push notification to the requester. The requester then may download the video from the server to the desktop and play the video.

As another example, an individual residing in Tehran, Iran, may use a desktop computer to request someone near a particular place, for instance, Laguna Beach in Laguna Beach, Calif., to record a three minute video of surf conditions at the beach. The request may be sent to the server and the server may send push notifications to responders who are within a predetermined area, for instance ten miles of the beach. Responders who are willing to perform the task may transmit their responses to the server and the server may select one respondent from the responders and provides the request to the respondent. As above, the respondent may have the option of streaming the video to the server or recording it on for future processing. Once the server receives the video, the server may notify the requester of the availability of the video and the requester may then download and view the video.

Some embodiments may allow the requester and the responders to communicate directly in a peer-to-peer (P2P) system without requiring a server. For instance, once the server has selected a respondent, the server may connect the requester to the respondent such that they can communicate directly.

Requests may not be limited to recording of video content. In certain settings, the request may involve recording of other multimedia. For instance, a request may ask for someone to enter a restaurant to observe an individual whose description is given in detail in the request. The respondent, who may not be able to capture video inside the restaurant, can observe the individual and enter text in his device describing what he is witnessing regarding the individual and also include photos of the individual in the restaurant.

There are over two billion people with smartphones in the world which all have cameras and recording capability. Some embodiments connect people who are in need of a way to witness a live event, person, object, etc. with users who would like to earn money by being the eyewitness for them using live streaming video.

Some embodiments use location services and global positioning satellite (GPS) technology to find users within the vicinity of a job location and send push notifications to such users about a task that has posted in their area.

Users may either post a task (“requesters”) or be the eye (“respondents” or “responders”) and earn money by accepting any of the posted tasks on the app.

For example, if a spouse states she is working late at the office and the other spouse has doubts, the other spouse may post a task asking for verification of whether a white minivan is seen at the parking lot of the work address of the spouse. The job may be posted and all users in that vicinity get a push notification.

Each potential responder may see how much is being offered and click an accept button if interested. Once accepted, the requester may view profiles of any responders and release the details of the job such that a responder may then confirm final acceptance and the job will stop accepting responses. For privacy reasons, on the map some embodiments may not disclose details on any spying related posts and may include only a spy icon and the rate offered.

Once the responder is on location, the requester may get push notification and may be able to open an app and watch the response live and communicate with the responder. If the requester is not available for live streaming, the finished clip may go into the inbox of the requester (and/or otherwise be stored or made available for the requester), the responder may get paid. The requester may be able to rate the responder after the assignment is complete.

As another example, a requester may receive a job offer in another state and need to find housing for relocation. The requester may identify three homes that fit the requirements of the requester, however the requester may not have time or resources to view the homes in person. The requester may hire an “eye” (or responder) to go out and live stream the properties and surrounding areas, thus avoiding paying for airline ticket, lodging, etc. and saving a lot of time.

Requesters may be required to pay the job cost upon creation of the job. For example, a requester may be willing to pay someone twenty dollars to inspect a car in another city. The requester may create an inspection task with the location of the car and pay the twenty dollars.

Next, the job may be made visible to other app users in the other city. The other users may apply to take the job.

The requester may then receive a notification when someone applies to take the job. The requester may review the profile and/or account information for the responder(s) prior to selecting or accepting a responder.

The selected responder may then perform the job and take a video of the car. The requester may watch the video live or via a recording.

The requester may then be able to accept the results or ask for additional media, communication, etc. from the responder.

Once the response is accepted, the responder may be paid the twenty dollars (or appropriate portion thereof).

### II. System Architecture

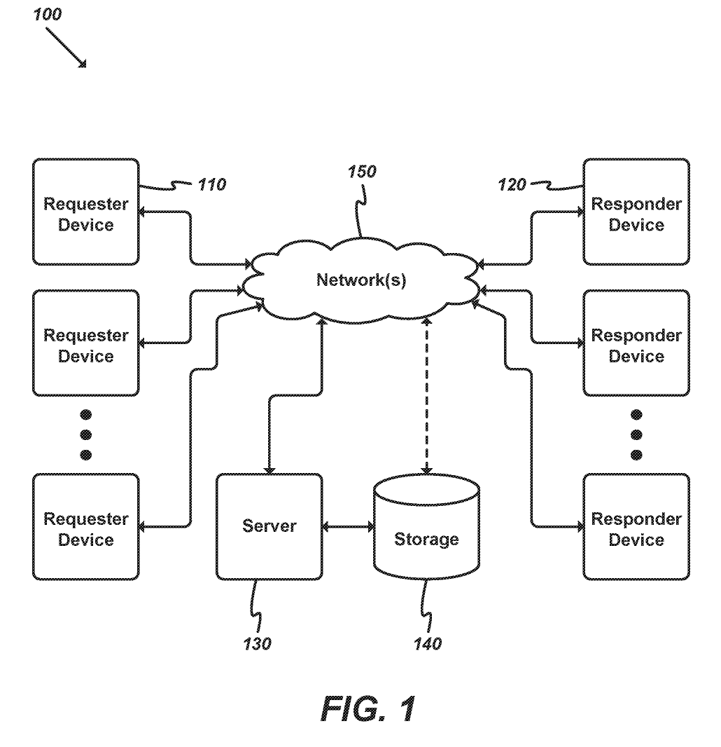

FIG. 1 illustrates a schematic block diagram of a distributed surveillance system 100 according to an exemplary embodiment. As shown, the system may include one or more requester devices 110, one or more responder devices 120, a server 130, a storage 140, and one or more networks 150.

The requester device 110 may be a device capable of accessing the network 150. The requester device 110 may include other capabilities such as media playback, text or voice communication, etc. The requester device may be a device such as a smartphone, tablet, personal computer (PC), wearable device, etc.

The responder device 120 may be a device capable of accessing the network 150. The responder device 120 may include other capabilities such a media capture, text or voice communication, etc. The responder device may be a device such as a smartphone, tablet, laptop, wearable device, etc.

The server 130 may include one or more electronic devices able to process instructions, manipulate data, and communicate across one or more networks 150. The server 130 may include multiple physical devices distributed across multiple physical locations.

The storage 140 may be able to store data and/or instructions for use by other system components. The storage may be accessible via the server 130, via one or more application programming interfaces (APIs), and/or other appropriate ways.

The network 150 may include local area networks, cellular networks, distributed networks, the Internet, etc. Such networks may utilize various types of communication paths, interfaces, etc. The networks may allow the various other system components to communicate.

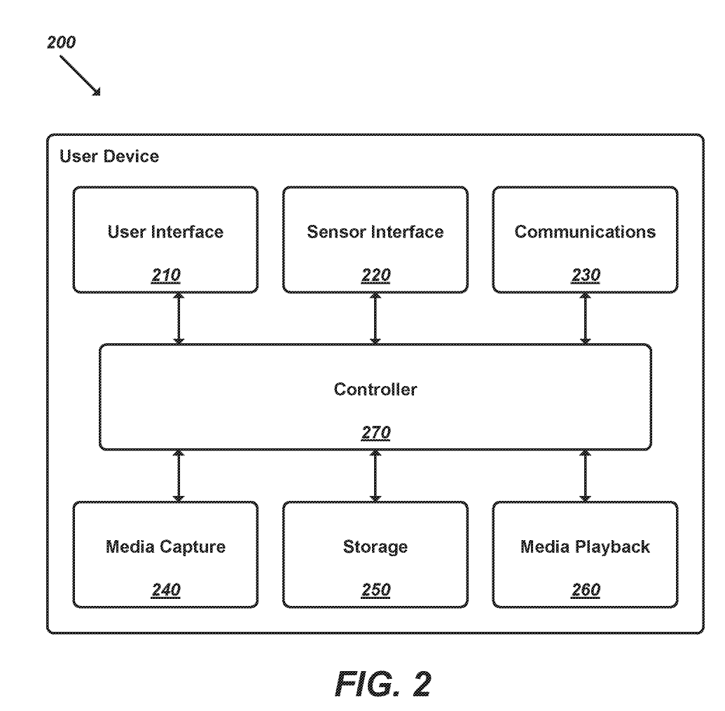

FIG. 2 illustrates a schematic block diagram of an exemplary user device 200 of the system 100. Such a user device 200 may serve as the requester device 110 and/or responder device 120. As shown, the user device 200 may include a user interface module 210, a sensor interface module 220, a communications module 230, a media capture module 240, a storage 250, a media playback module 260, and a controller 270.

The user interface module 210 may be able to receive various user inputs (e.g., via a touchscreen, keypad, buttons, voice input, etc.) and/or provide various outputs to a user (e.g., via a video display screen, speakers, haptic feedback, etc.).

The sensor interface module 220 may be able to direct, receive data from, and/or otherwise interact with any sensors included in the user device 200. Such sensors may include, for instance, GPS modules, accelerometers, temperature sensors, etc.

The communications module 230 may be able to send and/or receive communications across various appropriate pathways. Such pathways may include networks 150, local connections (e.g., Bluetooth, USB, etc.), and/or other appropriate communication pathways or resources (e.g., messaging platforms, cellular communications, etc.).

The media capture module 240 may be able to interact with various device hardware elements to capture media. Such hardware elements may include, for instance, cameras, microphones, etc. The captured media may include picture or video content, audio content, etc. In addition, some embodiments may capture other information such as sensor outputs, user inputs, etc.

The storage 250 may be able to receive, store, and/or provide data and/or instructions from/to the other system components. Such a storage may be local to the user device 200 and/or may be accessible to the user device via one or more wired and/or wireless connections.

The media playback module 260 may be able to retrieve or receive media and provide the media to a user. Such a module may be able to interact with various appropriate hardware modules (e.g., a display screen, speakers or other audio output, etc.).

The controller 270 may allow communication among the other components. In addition, the controller may at least partly direct the operations of the other components.

One of ordinary skill in the art will recognize that the system 100 and/or device 200 described above may be implemented in various different ways without departing from the scope of the disclosure. For instance, the components may be arranged in various different ways. As another example, additional components may be included and/or listed components may be omitted. In addition, multiple components may be combined into a single component and/or a single component may be divided into multiple sub-components.

### III. Methods of Operation

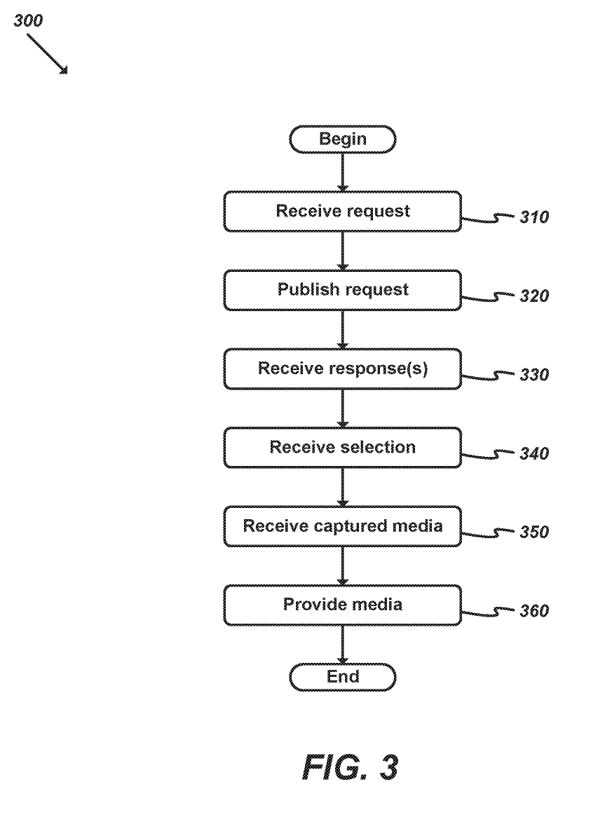

FIG. 3 illustrates a flow chart of an exemplary process 300 that provides distributed surveillance. Such a process may be executed by a system such as system 100 described above. The process may begin, for instance, when a user launches an application of some embodiments.

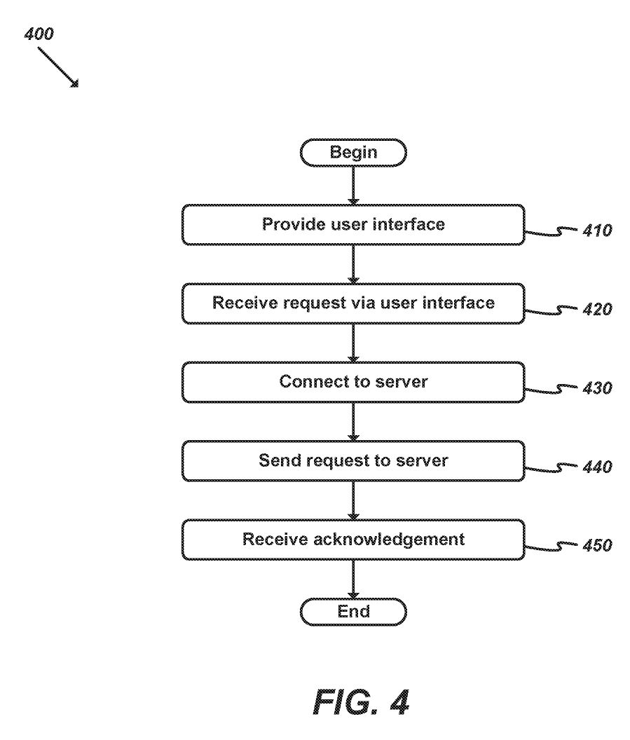

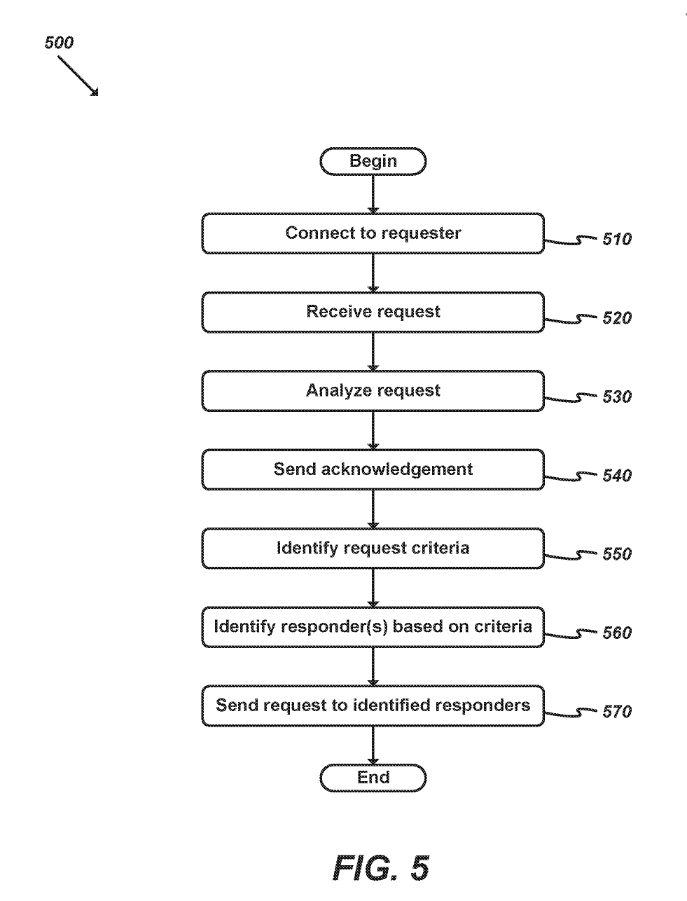

As shown, process 300 may receive (at 310) a task request. Such a request may be received via a requester device and passed to a server. The request may include various attributes, parameters, etc. For instance, the request may include a location, rate (i.e., an amount the requester is willing to pay for the service), a type (e.g., automobile, real estate, etc.), deadline, responder qualifications, and/or other appropriate information. Such request generation will be described in more detail below in reference to FIGS. 4 and 5.

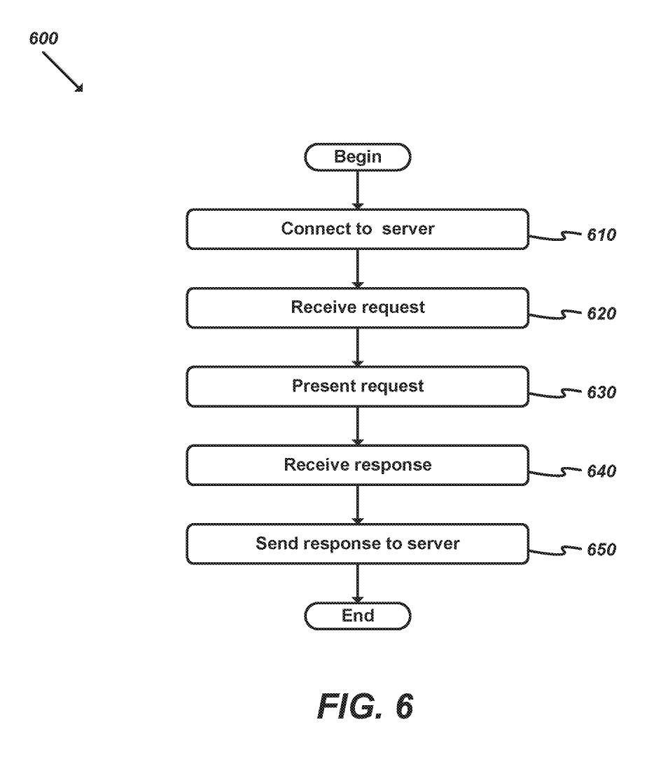

Next, the process may publish (at 320) the request. Such publication may be made based on various appropriate criteria (e.g., type of request, location of users, etc.). The publication may include pushing the task to potential responders, making the task available for viewing by potential responders, etc. Some embodiments may identify potential responders from among a group of responder-users based on various appropriate criteria. Such criteria may be associated with the requester (e.g., location of request, experience level, etc.) and/or the responder (e.g., distance willing to travel, availability, etc.). Such request publication will be described in more detail in reference to FIGS. 5 and 6.

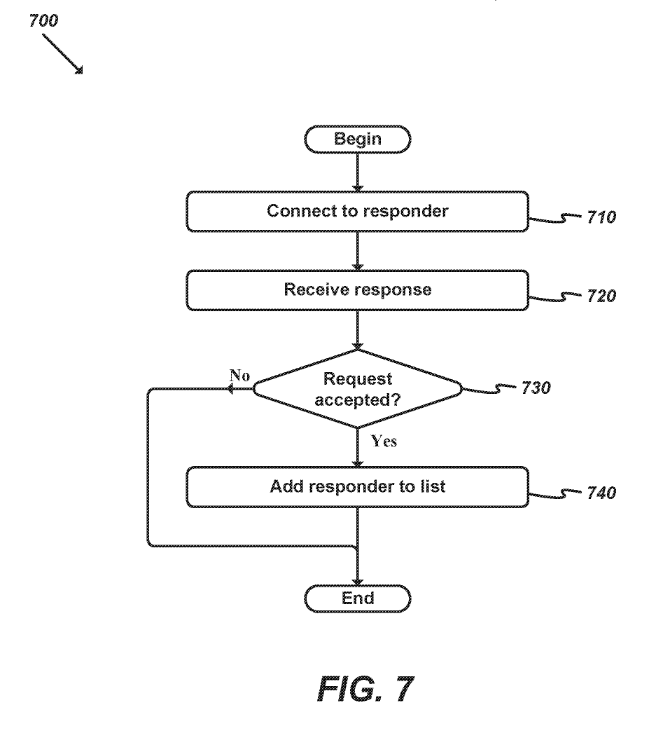

The process may then receive (at 330) responses to the published request. Such responses may be received at the server via a responder device. The affirmative responses may be added to a candidate or potential responder list. Such response handling will be described in more detail below in reference to FIGS. 6 and 7.

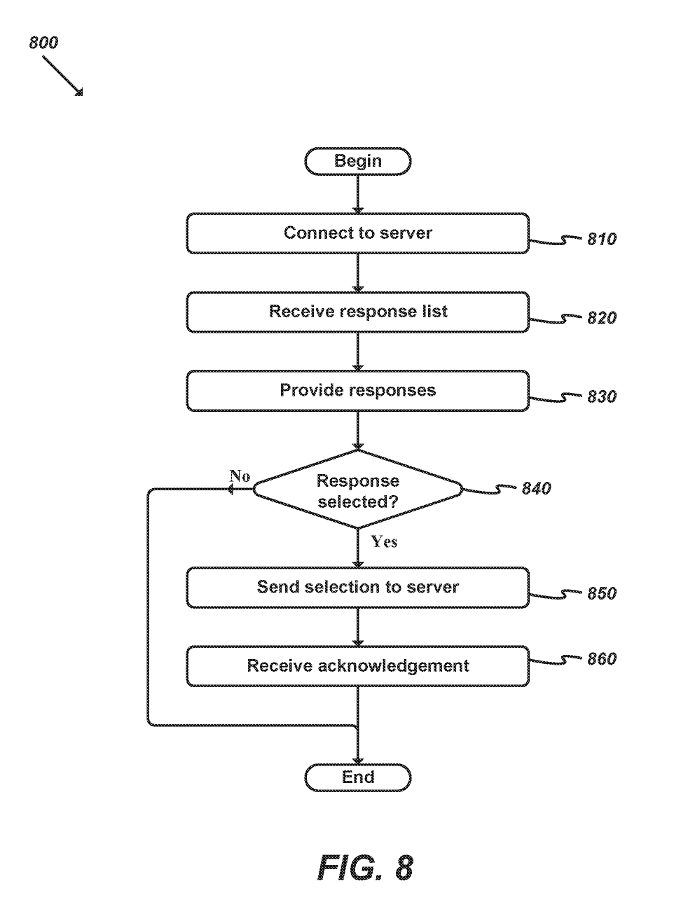

Next, the process may receive (at 340) a selection from among the responders and assign the task to the selected responder. Such a selection may be made in various appropriate ways. For instance, some embodiments may send the list of candidates for review and selection by the requester. Alternatively, some embodiments may automatically select and assign a task to a responder. Such selection and assignment will be described in more detail below in reference to FIGS. 8-10.

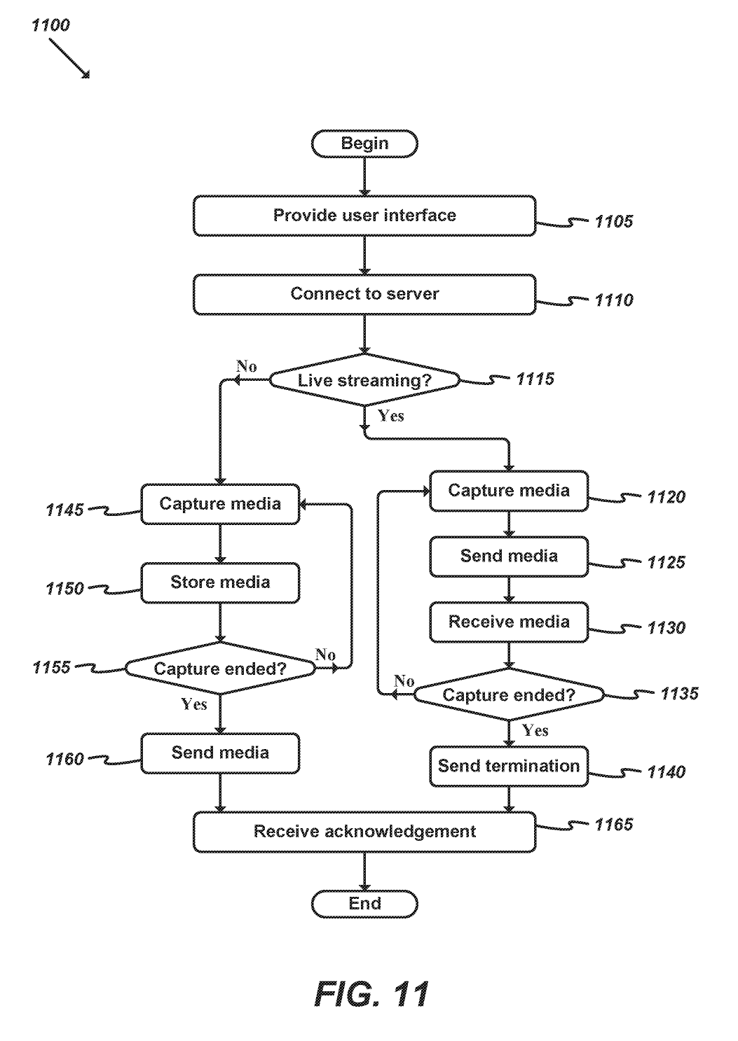

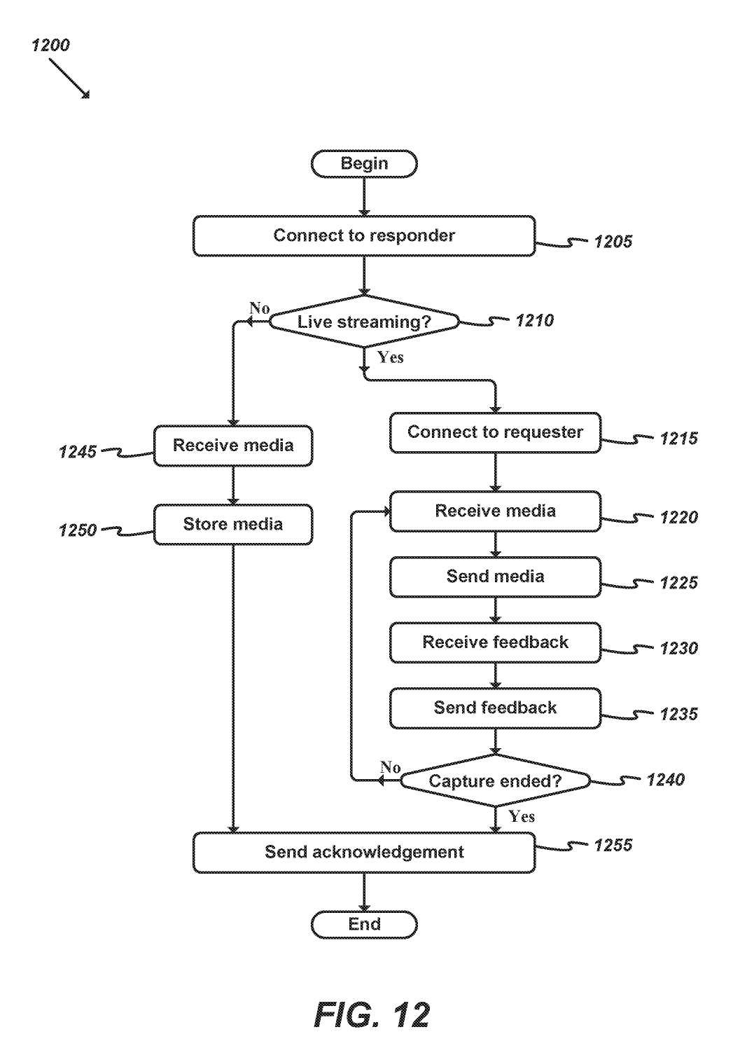

Process 300 may then receive (at 350) captured media from the responder. The media may be captured at a responder device. Depending on the type of capture/provision, the media may be provided to the requester in real time (e.g., as streaming video). Alternatively, the media may be stored and made available for later download and/playback by the requester. Some embodiments may relay the media via a server. Alternatively, the media may be sent from a responder device to a requester device without involving the server of some embodiments (e.g., via a peer-to-peer network). Such media capture will be described in more detail below in reference to FIGS. 11 and 12.

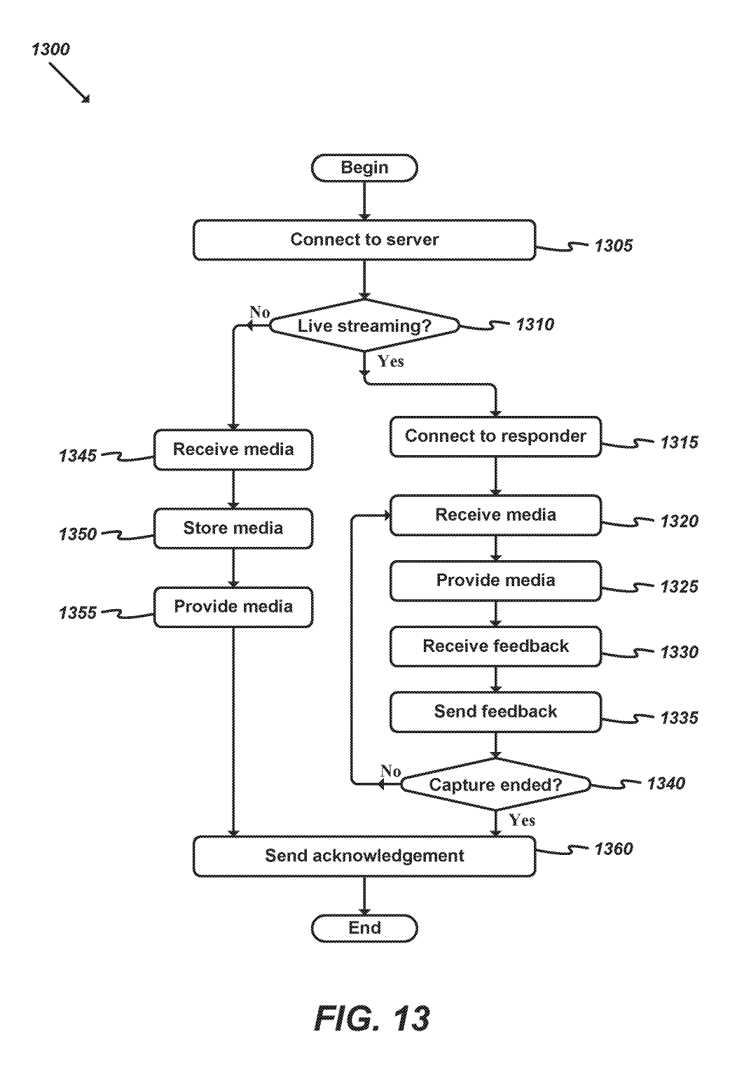

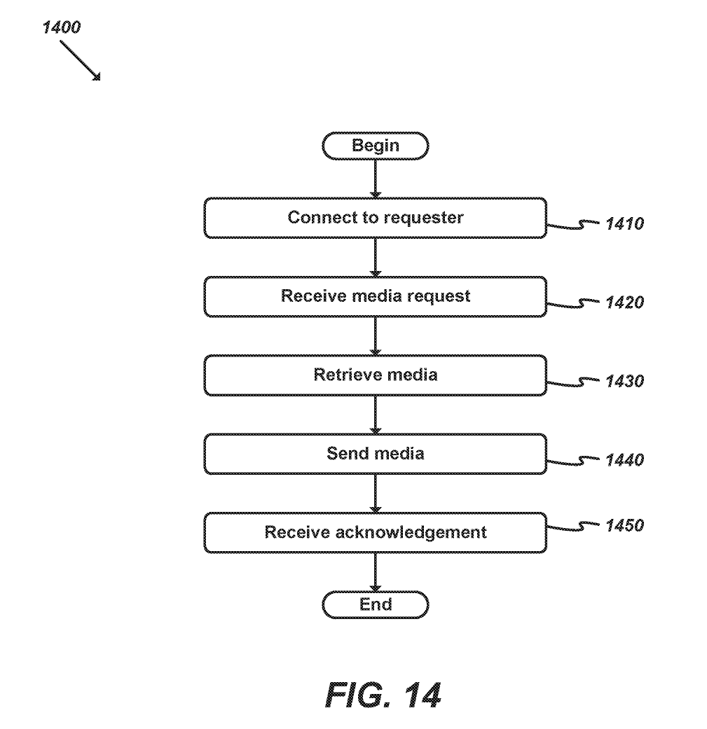

Finally, the process may provide (at 360) the captured media to the requester and then may end. As above, in a real-time environment the media may be relayed from the responder device to the requester device. Alternatively, the requester may access the media (e.g., at the server) for download and/or playback after the event is complete. In addition to transferring media, other information or communication may be provided. For instance, a responder may be able to type in answers to various questions that may be associated with a request for services. As another example, some embodiments may allow two-way communication via voice, text, etc. during a real time session. Such media provision will be described in more detail below in reference to FIGS. 13 and 14.

FIG. 4 illustrates a flow chart of an exemplary client-side process 400 that receives surveillance requests. Such a process may be executed by a device such as user device 200 described above. The process may begin, for instance, when a user launches an application of some embodiments.

As shown, process 400 may provide (at 410) a user interface (UI). Such a user interface may be similar to the exemplary GUIs described below in Section IV. The UI may be provided via a user device app, a web browser, and/or other appropriate resource. The UI may include visual input/output elements (e.g., touch screen elements), physical input/output elements (e.g., keypads, buttons, speakers, microphone, etc.), and/or other appropriate UI elements. In this example, the UI is related to a requester generating a request for services. Other UIs may be provided based on relevant criteria (e.g., user type, user selections, default values, status, etc.).

Next, the process may receive (at 420) a request via the UI. Such a request may include various attributes. Some attributes may be required (e.g., location, rate, etc.) while others may be optional or only applicable to certain types of requests (e.g., square footage of a house for a real estate review, specific options related to an automobile, etc.).

The process may then connect (at 430) to the server. Such a connection may include various verification or confirmation operations. For instance, the user may have to supply a username and/or password when launching the app, when a request is sent to the server, etc. In addition, the client device and server may send various handshake or other messages in order to establish a communication channel. Such messaging and/or interface requirements may depend on the type(s) of devices, available communication pathway(s), and/or other relevant factors.

Process 400 then may send (at 440) the request to the server, receive (at 450) an acknowledgement from the server, and then may end. The request may include the information provided by the requester, information related to the user or user account, and/or other appropriate information. The acknowledgement may include an acceptance or validation element or flag and/or other appropriate information.

FIG. 5 illustrates a flow chart of an exemplary server-side process 500 that receives surveillance requests. Process 500 may be complementary to a process such as process 400 described above. A process such as process 500 may be executed by a device such as server 130 described above. The process may begin, for instance, when a user device sends a connection request to the server.

As shown, process 500 may connect (at 510) to the requester. Such a connection may be made in a similar way to that described in reference to operation 430 above. Next, the process may receive (at 520) a request for a task. The process may then analyze (at 530) the request and send (at 540) a response based on the analysis. The analysis may include determining whether the request is complete, valid, or otherwise satisfies some submission criteria. The acknowledgement may include a receipt acknowledgement, and indication of identified issues or errors, and/or other appropriate information.

The process may then identify (at 550) the request criteria based on the analysis. The request criteria may include, for instance, proximity, availability, rate, type, etc. Next, the process may identify (at 560) potential responders based on the criteria. For instance, responders may be able to specify that they are only interested in certain types of jobs (e.g., automobile inspections only), will only travel to certain areas, schedule of availability, etc. Responders that fail to satisfy some criteria may not be added to a list of potential responders (or may be removed from such a list).

Finally, the process may send (at 570) the request to the identified potential responders and then may end. The request may be sent as a push message via an app on the responder mobile device. Alternatively, messages may be made available for retrieval and sent when a request is made by the responder.

FIG. 6 illustrates a flow chart of an exemplary client-side process 600 that presents surveillance requests to potential responders. Such a process may be executed by a device such as user device 200 described above. The process may begin, for instance, when a user launches an application of some embodiments.

As shown, process 600 may connect (at 610) to the server and receive (at 620) a request. As above, in some embodiments the request may be automatically received as a push message.

Next, the process may present (at 630) the request. Such a request may be presented via an appropriate UI. Some such example UIs will be described in more detail in Section IV below.

The process may then receive (at 640) a response to the request. Such a response may include an indication (e.g., apply or accept, decline, etc.) and/or other appropriate information (e.g., expected completion date, requests for additional information, etc.).

Finally, the process may send (at 650) the response to the server and then may end.

FIG. 7 illustrates a flow chart of an exemplary server-side process 700 that receives responses to surveillance requests from. Process 700 may be complementary to a process such as process 600 described above. A process such as process 700 may be executed by a device such as server 130 described above. The process may begin, for instance, when a user device sends a connection request to the server.

As shown, process 700 may connect (at 710) to the responder and receive (at 720) a response. As above, the response may include an indicator and/or other information.

Next, the process may determine (at 730) whether the request was accepted. Such a determination may be made based on the indicator from the received response.

If the process determines the request was not accepted, the process may end. If the process determines that the request was accepted, the process may add (at 740) the responder to the list and then may end.

FIG. 8 illustrates a flow chart of an exemplary client-side process 800 that receives response selections from requesters. Such a process may be executed by a device such as user device 200 described above. The process may begin, for instance, when a user with an active request launches an application of some embodiments.

As shown, process 800 connect (at 810) to the server and receive (at 820) the response list. The response list may include all responder who have submitted an affirmative response regarding the request. The responses may be provided (at 830) to the requester via an appropriate UI, such as the exemplary GUIs described below in Section IV.

Next, the process may determine (at 840) whether a response (and associated responder) has been selected by the requester. Such a selection may be made in various appropriate ways (e.g., selecting a specific responder from a list, affirming a single responder, etc.).

If the process determines that a response has been selected, the process may then send (at 850) the selection to the server, receive (at 860) an acknowledgement and then may end. If the process determines (at 840) that no response has been selected, the process may end.

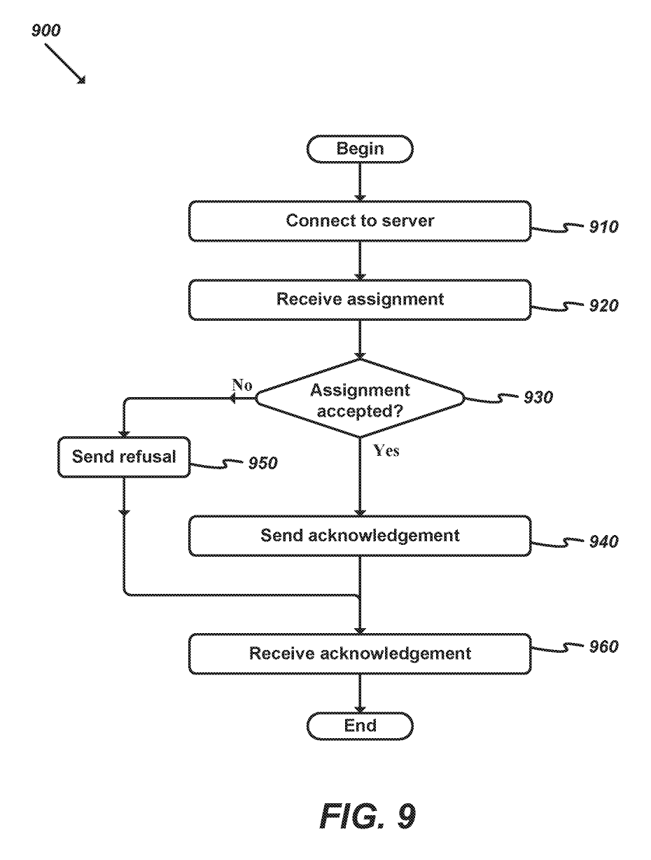

FIG. 9 illustrates a flow chart of an exemplary client-side process 900 that presents assignments to responders. Such a process may be executed by a device such as user device 200 described above. The process may begin, for instance, when a user associated with an accepted response launches an application of some embodiments.

As shown, process 900 may connect (at 910) to the server and receive (at 920 any assignments. Such assignments may be sent as push notifications, retrieved when the app is launched, and/or otherwise sent.

Next, the process may determine (at 930) whether the potential responder has accepted the assignment. Such a determination may be made based on various relevant factors (e.g., inputs received from the responder). If the process determines that the potential responder has accepted the assignment, the process may send (at 940) an acknowledgement message. If the process determines (at 930) that the assignment was not accepted, the process may send (at 950) a refusal message.

Process 900 may then receive (at 960) an acknowledgement of the acceptance or refusal and then may end.

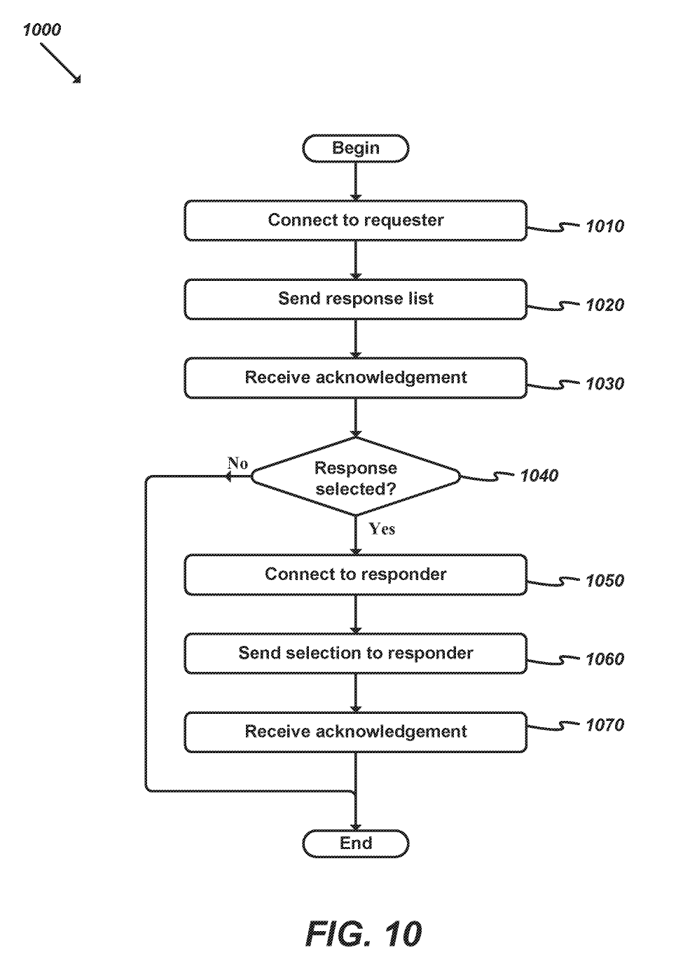

FIG. 10 illustrates a flow chart of an exemplary server-side process 1000 that receives response selections from requesters and sends assignments to selected responders. Process 1000 may be complementary to a process such as process 900 and/or process 800 described above. A process such as process 1000 may be executed by a device such as server 130 described above. The process may begin, for instance, when a user device sends a connection request to the server.

As shown, process 1000 may connect (at 1010) to a requester. Next, the process may send (at 1020) a response list for any open assignments requested by the requester. The process may then receive (at 1030) an acknowledgement message from the requester device.

Next, the process may determine (at 1040) whether a response (and associated responder) has been selected. Such a selection may be made based on various relevant factors (use selections, default settings, etc.). If the process determines that no response has been selected, the process may end.

If the process determines that a response has been selected, the process may connect (at 1050) to the selected responder, send (at 1060) a selection notification to the responder device, receive (at 1070) acknowledgment from the responder and then may end.

FIG. 11 illustrates a flow chart of an exemplary client-side process 1100 that captures and processes media for a responder. Such a process may be executed by a device such as user device 200 described above. The process may begin, for instance, when a user launches an application of some embodiments.

As shown, process 1100 may provide (at 1105) a UI. Such a user interface may include various appropriate elements for capturing media (e.g., a viewfinder, record controls, etc.). In addition, such an interface may allow two-way communication with a requester during live streaming. Next, the process may connect (at 1110) to the server.

The process may then determine (at 1115) whether the session will be live. Such a determination may be made based on various relevant factors (e.g., availability of the requester, quality of network connection, etc.).

If the process determines that the session will be live streaming, the process may then capture (at 1120) the media. Such media capture may involve, for instance, using a device camera to capture video or still images. In addition, some embodiments may capture communications from the responder (e.g., text, voice, etc.) for transmission to the requester.

The process may then send (at 1125) the captured media. In some embodiments the media may be sent to the server for further distribution to the requester. Alternatively, the captured media may be sent over a P2P channel.

Next, the process may receive (at 1130) media. Such media may include, for instance, text or voice communications from the requester.

The process may then determine (at 1135) whether the capture has ended. Such a determination may be made based on various relevant factors (e.g., selection of a “stop” button by the responder, termination of the session by the responder or requester, etc.). The process may repeat operations 1120-1135 until the process determines (at 1135) that capture has ended. Process 1100 may then send (at 1140) a termination notification to the server and/or requester.

If the process determines (at 1115) that live streaming will not be used, the process may capture (at 1145) and store (at 1150) the media. The media may be stored locally at the capture device and/or may be transmitted to the server (at time of capture or at a later time, such as when a connection is available).

Next, the process may determine (at 1155) whether the capture has ended. The process may repeat operations 1145-1155 until the process determines (at 1155) that capture has ended. The process may then send (at 1160) the captured media to the server and/or requester.

After sending (at 1140) a termination message or after sending (at 1160) the captured media, the process may receive (at 1165) an acknowledgement message from the server or requester device and then may end.

FIG. 12 illustrates a flow chart of an exemplary server-side process 1200 that captures and processes media from a responder. Process 1200 may be complementary to a process such as process 1100 described above. A process such as process 1200 may be executed by a device such as server 130 described above. The process may begin, for instance, when a user device sends a request to deliver captured media.

As shown, process 1200 may connect (at 1205) to a responder. Next, the process may determine (at 1210) whether the session will be live streaming. If the process determines that the session will be live, the process may connect (at 1215) to the requester.

Process 1200 may then receive (at 1220) captured media from the responder and send (at 1225) the media to the requester. Next, the process may receive (at 1230) feedback from the requester and send (at 1235) the feedback to the responder. The process may then determine (at 1240) whether capture has ended. The process may repeat operations 1220-1240 until the process determines (at 1240) that capture has ended.

If the process determines (at 1210) that the session will not be live, the process may receive (at 1245) the captured media and store (at 1250) the received media for later delivery to the requester.

After determining (at 1240) that capture has ended or after storing (at 1250) the media, the process may send (at 1255) acknowledgement messages to the responder and/or requester, as appropriate, and then may end.

FIG. 13 illustrates a flow chart of an exemplary client-side process 1300 that retrieves and presents media to a requester. Such a process may be executed by a device such as user device 200 described above. The process may begin, for instance, when a user launches an application of some embodiments.

As shown, process 1300 may connect (at 1305) to the server. Next, the process may determine (at 1310) whether the session is live streaming. If the process determines that the session is live, the process connect (at 1315) to the responder.

Next, the process may receive (at 1320) captured media and provide (at 1325) the media to the requester (e.g., by displaying video content). Such captured media may include communications from the responder. The process may then receive (at 1330) feedback from the requester, if any and send (at 1335) the feedback to the responder.

Process 1300 may then determine (at 1340) whether the capture has ended. If the process determines that capture has not ended, the process may repeat operations 1315-1340 until the process determines (at 1340) that capture has ended.

If the process determines (at 1310) that the session is not live streaming, the process may receive (at 1345) the media. Such media may be retrieved from the server or from the storage via an API. Next, the process may store (at 1350) the received media. Alternatively, some embodiments may deliver the stored media as a stream that does not require the user to download a complete file. The process may then provide (at 1355) the media to the requester (e.g., by launching a media player or within the app of some embodiments).

After providing (at 1355) the media or determining (at 1340) that capture has ended, the process may send (at 1360) acknowledgement messages to the server and/or responder device and then may end.

FIG. 14 illustrates a flow chart of an exemplary server-side process 1400 that retrieves and provides media to a requester. Process 1400 may be complementary to a process such as process 1300 described above. In a streaming implementation, process 1200 may be complementary to a process such as process 1300. A process such as process 14500 may be executed by a device such as server 130 described above. The process may begin, for instance, when a user device sends a media request to the server.

As shown, process 1400 may connect (at 1410) to the requester. Next, the process may receive (at 1420) a media request for media associated with an assignment.

The process may then retrieve (at 1430) the requested media and send (at 1440) the requested media to the requester. Next, the process may receive (at 1450) an acknowledgement or termination message and then may end.

One of ordinary skill in the art will recognize that the processes described above may be implemented in various different ways without departing from the scope of the disclosure. For instance, the various operations may be performed in different sequences, some listed operations may be omitted, and/or some additional operations may be included. In addition, the processes (and/or portions thereof) may be performed iteratively and/or based on some specified criteria. Furthermore, each process may be included as part of a larger macro process or divided into multiple sub-processes.

For instance, some embodiments may provide processes that allow for billing, payment, etc. to be managed during jobs and/or after completion. As another example, various processes may be used to authenticate or validate users before access to some elements is provided.

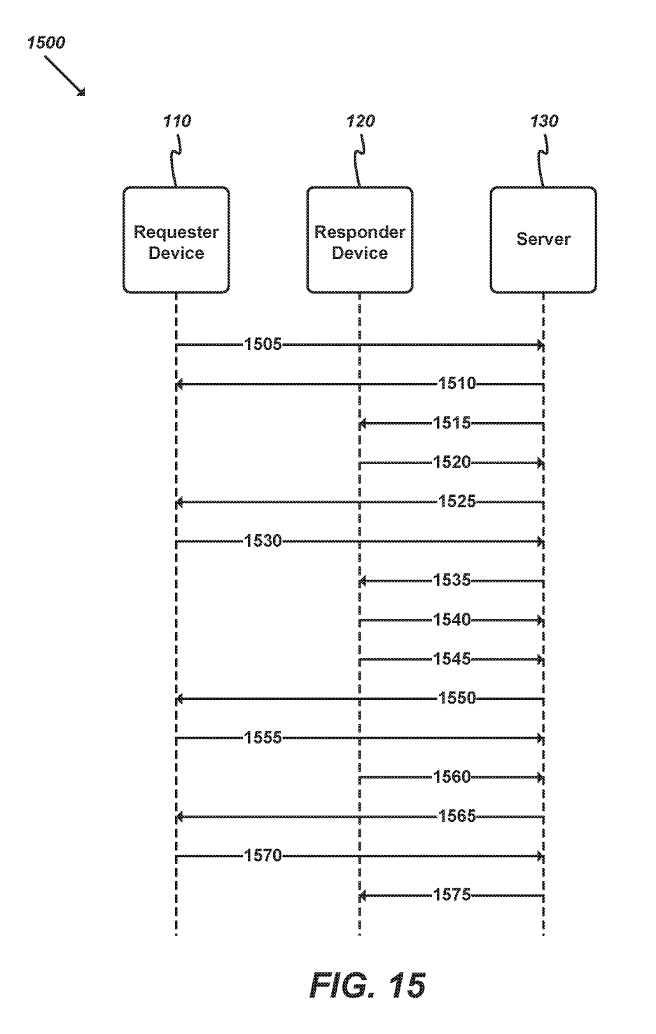

FIG. 15 illustrates a message flow diagram of an exemplary communication algorithm 1500. The diagram include a requester device 110, a responder device 120, and a server 130, as shown.

As shown, the requester device may send an assignment request message 1505 to the server. Such a message may include information related to an assignment (e.g., type, rate, location, etc.). Next, the requester 110 may receive a confirmation or acknowledgement message 1510 from the server 130.

The server may then send a request message 1515 to the responder 120 and receive an acknowledgement message 1520. Messages 1515-1520 may be repeated for multiple potential responders.

Next, the server 130 may send a candidate list message 1525 to the requester 110. The requester may respond with a candidate selection message 1530.

Based on the received selection, the server 130 may send an assignment message 1535 to the responder 120 and receive an acknowledgement message 1540 accepting the assignment.'

Next, the responder 120 may send a capture ready message 1545 when capture is about to begin. The server 130 may, in turn, send a connection message 1550 to the requester 110 if the session is to be live streaming. The requester may respond with an acknowledgement message 1555 to the server 130 indicating whether the requester 110 is ready for streaming. For cases where the content is to be stored and retrieved at a later time, messages 1550 and 1555 may be omitted.

Next, the responder 120 may transmit captured media 1560 to the server 130. If the session is not live, the server may simply store the received media. If the session is live, the server may transmit the captured media 1565 to the requester 110. The requester may send feedback 1570, as appropriate. Finally, the server may relay the feedback 1575 to the responder 120. Operations 1560-1575 may be repeated until the session is terminated.

One of ordinary skill in the art will recognize that different embodiments may use different specific messages and/or sequences of messages. Such algorithms may be depend on various user actions or selections (e.g., whether session will be live or not). In addition, although various messages have been represented as single entities flowing in a single direction, one of ordinary skill would recognize that each message show in FIG. 15 may be implemented using multiple messages that may be transmitted back and forth between the appropriate resources (and/or other additional resources).

### IV. Usage Scenarios

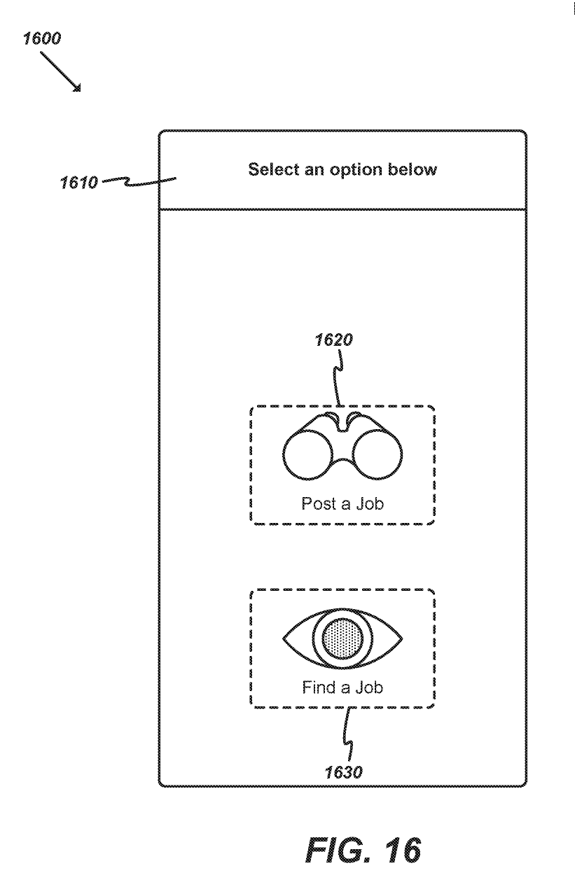

FIG. 16 illustrates an exemplary graphical user interface (GUI) 1600 that presents surveillance options to users. Such an interface may be invoked, for instance, when an application of some embodiments is launched. As shown, this example interface may include a title or direction 1610, and various options 1620-1630 associated with various types of users. In some embodiments, a selection may be made automatically. For instance, a user may specify that the user is only interested in finding jobs and not posting jobs.

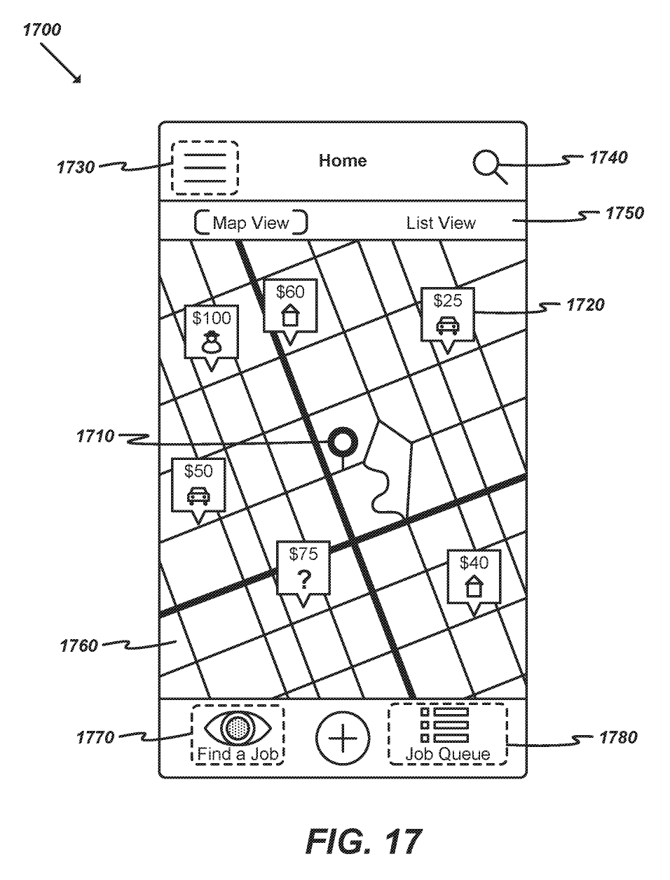

FIG. 17 illustrates an exemplary GUI 1700 that presents requests to potential responders using a map-based view. Such an interface may be invoked, for instance, by selecting an element such as object 1630 described above. As shown, this example interface 1700 may include a location marker 1710, various open tasks 1720, a setting selector 1730, a search element 1740, a view selector 1750, a map background 1760, a find a job button 1770, and a job queue selector 1780.

The location marker 1710 may indicate the current location of the user relative to the map 1760. Each open task indicator 1720 may include an icon or other type indicator, a compensation amount or rate, and/or other appropriate information. The open task indicators may be selectable, allowing a user to press the indicator to open the task.

The setting selector 1730, search element 1740 and/or other such elements may allow a user to invoke a drop-down menu or other appropriate selector or indicator or activate other appropriate GUI elements (e.g., a search box).

The view selector 1750 may allow a user to select from among various types of views.

The map background 1760 may include map information for the surrounding area.

Various other buttons and selectors such as a browse jobs feature 1770, job queue selector 1780, and/or other appropriate elements may be included (e.g., add project).

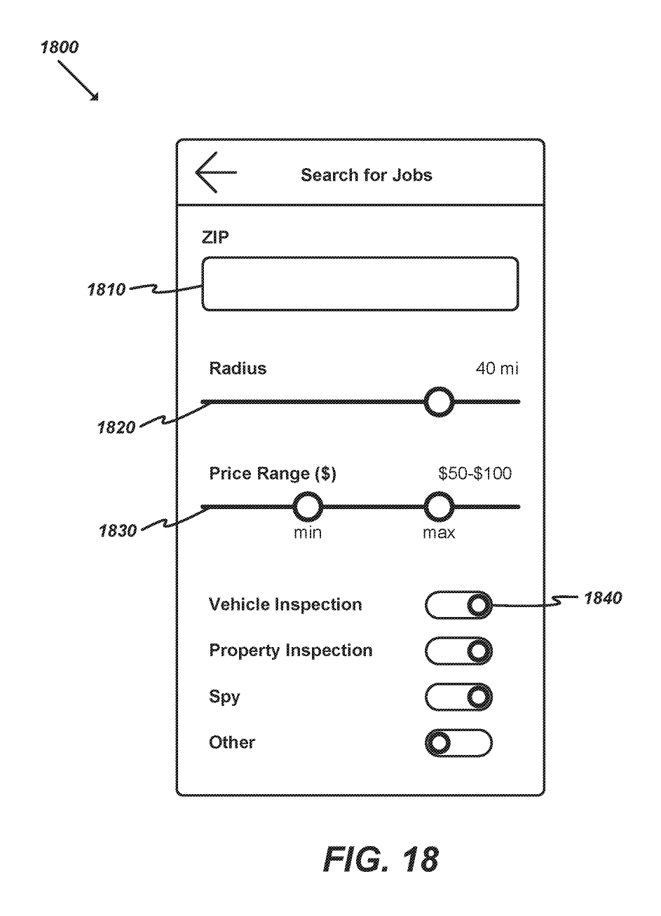

FIG. 18 illustrates an exemplary GUI 1800 that allows responders to search for available requests. Such an interface may be invoked, for instance, when an object such as option 1770 described above is selected or otherwise activated. As shown, the GUI 1800 may include a location entry block 1810, an availability radius selector 1820, a price range selector 1830, and various feature enable sliders 1840.

The location entry block 1810 may allow a user to set a location for a prospective task. The location may be set in various appropriate ways (e.g., typing a city and state, ZIP code, neighborhood, etc.). In some embodiments, the location entry block may automatically identify a location of the user (e.g., using GPS).

The radius slider 1820 and price range slider 1830, among other possible range selectors, may be used to select within various available ranges or thresholds. Different embodiments may allow users to set various different values, flags, etc. for various different parameters.

The enable/disable sliders 1840 may be used to activate and/or deactivate various features or attributes. In this example, the user may indicate the types of jobs the user may be interested in performing.

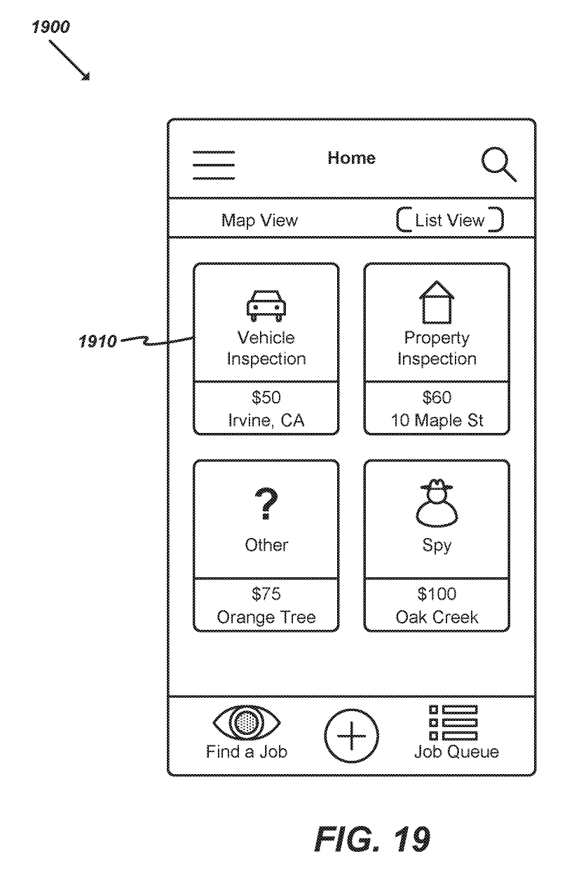

FIG. 19 illustrates an exemplary GUI 1900 that presents requests to potential responders using a list-based view. Such a GUI may be invoked, for instance, when a selection of “list view” is received via element 1750 described above. As shown, this example interface 1900 includes various tiles 1910 representing the potential tasks.

Each tile 1910 may include information related to the job type, rate, location, etc. Such tiles may be selectable (e.g., a user may be able to press a tile to select that job).

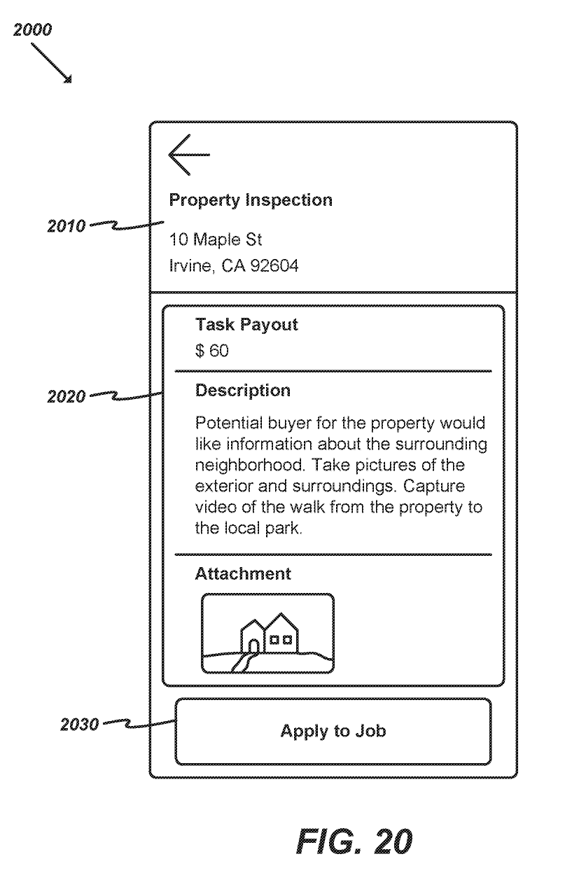

FIG. 20 illustrates an exemplary GUI 2000 that presents a request to a potential responder. Such a GUI may be invoked by selecting an element such as indicator 1720 or one of the tiles 1910 described above. As shown, the GUI 2000 may include a demographic information field 2010, a task description tile 2020, and a task application button 2030.

The information field 2010 may include various appropriate elements (e.g., type of project, location, etc.).

The description tile 2020 may include various descriptive elements related to the job (e.g., payout, description, etc.). In this example, the description tile includes a photo attachment. Such a photo may be used to help identify the property or person to be viewed. Different jobs may allow different types or numbers of attachments.

The task application button 2030 may allow a responder to apply for the given task.

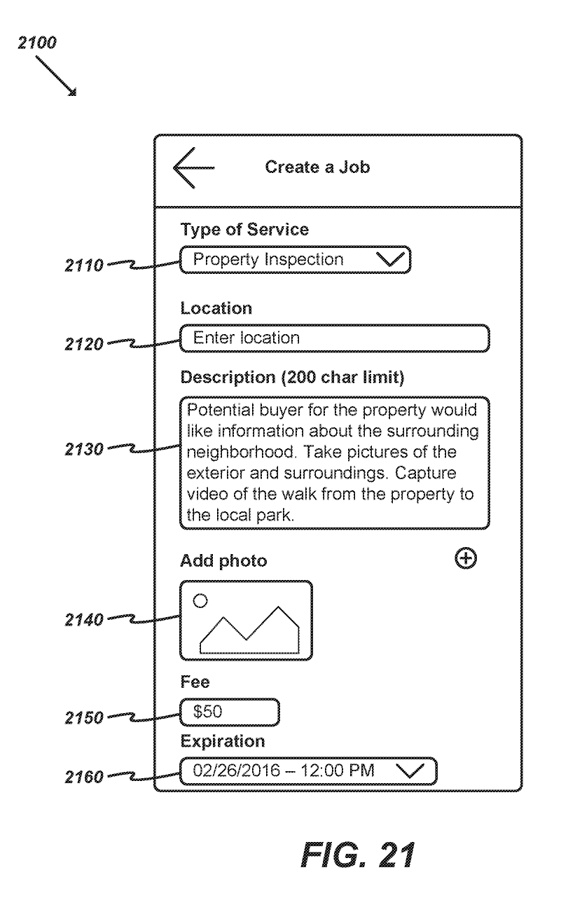

FIG. 21 illustrates an exemplary GUI that generates a request. Such an interface may be invoked, for instance, by selecting an element such as object 1620 described above. As shown, this example interface 2100 may include a type selector 2110, location entry box 2120, description entry box 2130, attachment feature 2140, fee input element 2150, and an expiration selector 2160.

The various elements 2110-2160 may allow text entry, selection from among a set of options, etc., as appropriate, based on the specific parameter (e.g., types of jobs may be limited to specific options, while a description may allow for many specific arrangements of characters, a fee may be limited to a specified range, etc.) and/or other relevant factors (e.g., user history, default options, user selections, etc.).

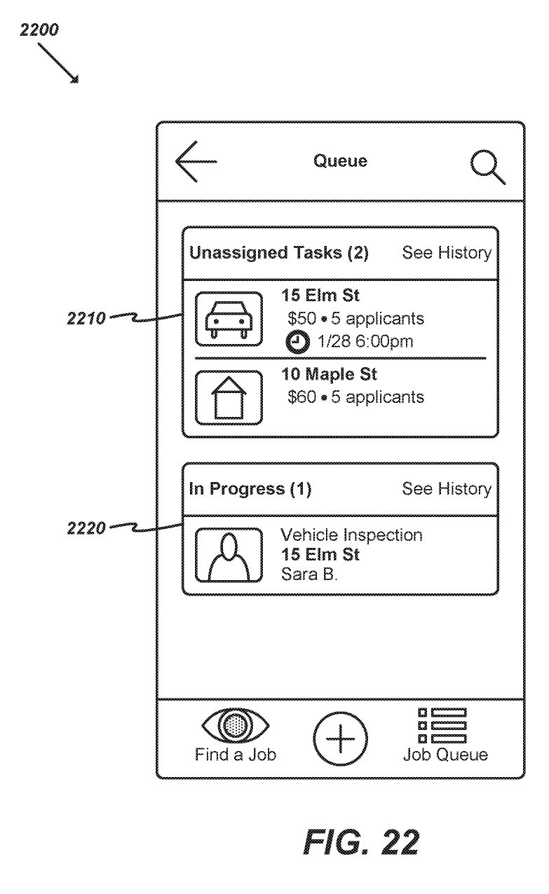

FIG. 22 illustrates an exemplary GUI 2200 that presents a queue to a requester. Such a GUI may be invoked, for instance, when a job is created using GUI 2100, when a selection of an element such as element 1780 is received, and/or under other appropriate conditions (e.g., a requester launches an app of some embodiments, when a user has unassigned tasks, etc.). This example interface 2200 includes a tile 2210 with two unassigned tasks and a tile 2220 with one assigned, in progress task.

This example GUI may allow a requester to see a summary of all tasks, review number of responses, view deadlines, etc.

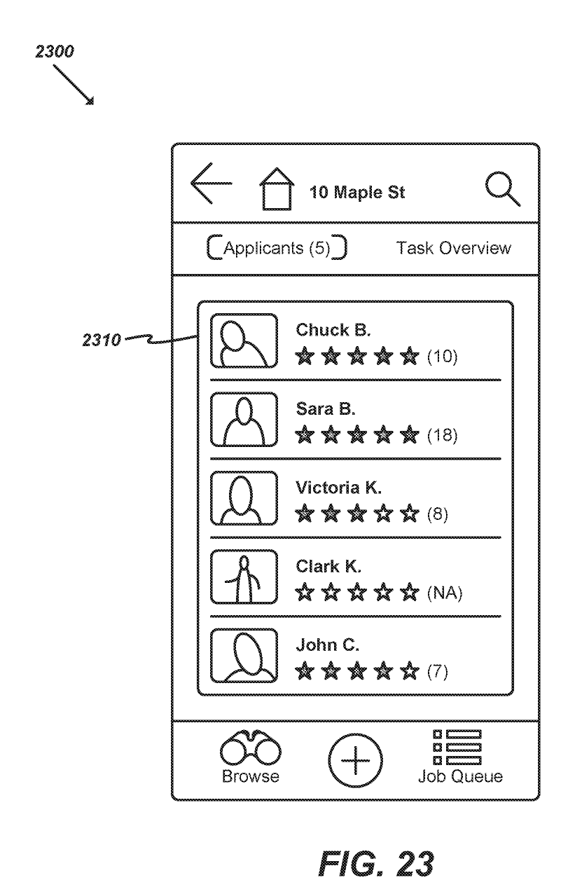

FIG. 23 illustrates an exemplary GUI 2300 that provides a list of responders to a requester. Such a GUI may be invoked, for instance, by selecting an unassigned task using interface element 2210 described above. As shown, the GUI 2300 may include a tile 2310 listing the various applicants (and/or potential applicants) for a job.

The tile 2310 may include information for each candidate or applicant, such as a photo, name or alias, rating, etc. Some applicants may be presented based on specific actions (e.g., a responder applies for a job) or bases on some evaluation criteria (e.g., all active users that serve the specified location may be listed as potential applicants).

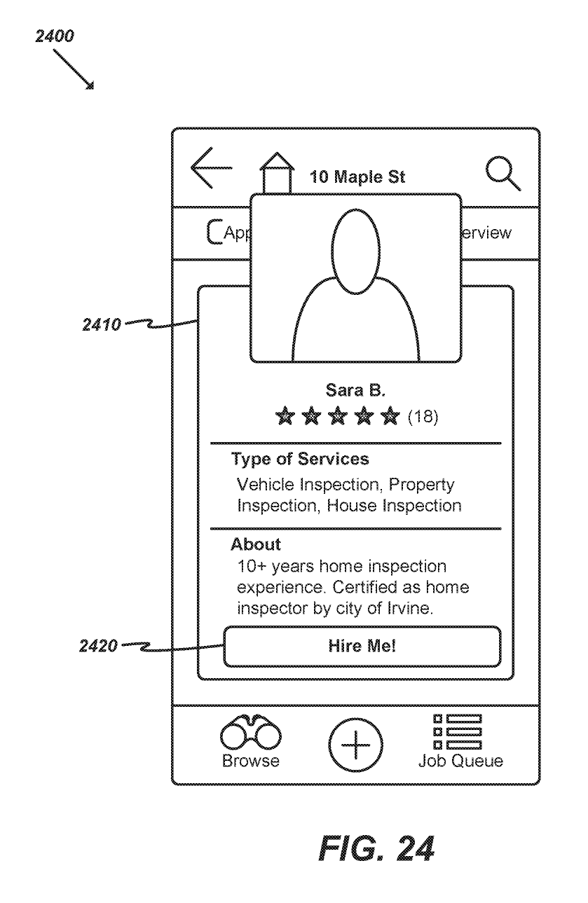

FIG. 24 illustrates an exemplary GUI 2400 that provides information regarding a particular responder. Such a GUI may be invoked, for instance, by selecting a potential responder using interface element 2310 described above. As shown, the GUI 2400 may include a responder tile 2410, and a selection button 2420.

The responder information tile 2410 may include information related to the responder, such as name or alias, photo, rating, types of services offered, biographic information, reviews of previous jobs, etc.

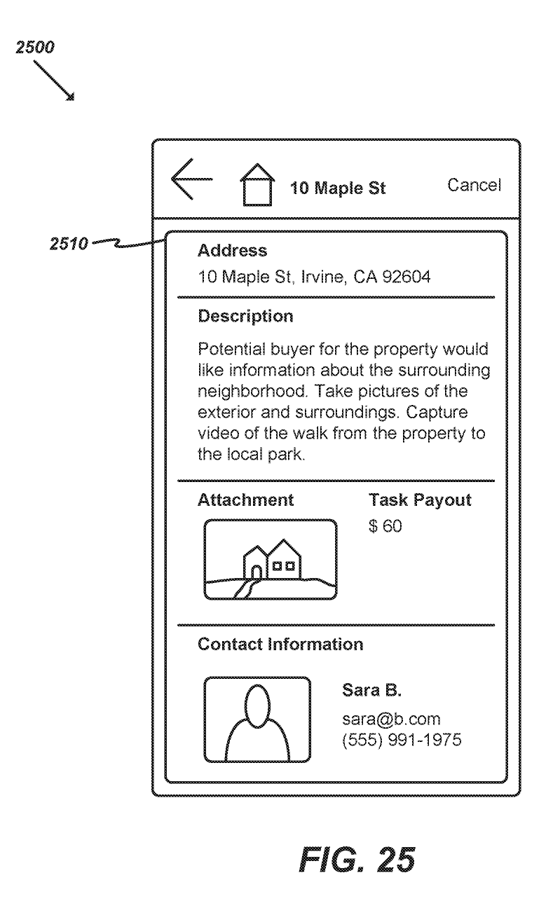

FIG. 25 illustrates an exemplary GUI 2500 that provides information regarding a request after a responder has been selected. Such an interface may be invoked, for instance, by selecting an element such as object 2420 described above. As shown, the GUI 2500 may include a task summary tile 2510.

The task summary tile 2510 may include information related to the task and assigned responder (when viewed by a requester). A similar tile may include information related to the requester (when viewed by a responder). In some embodiments, after media has been captured, a requester may access the media from a similar GUI.

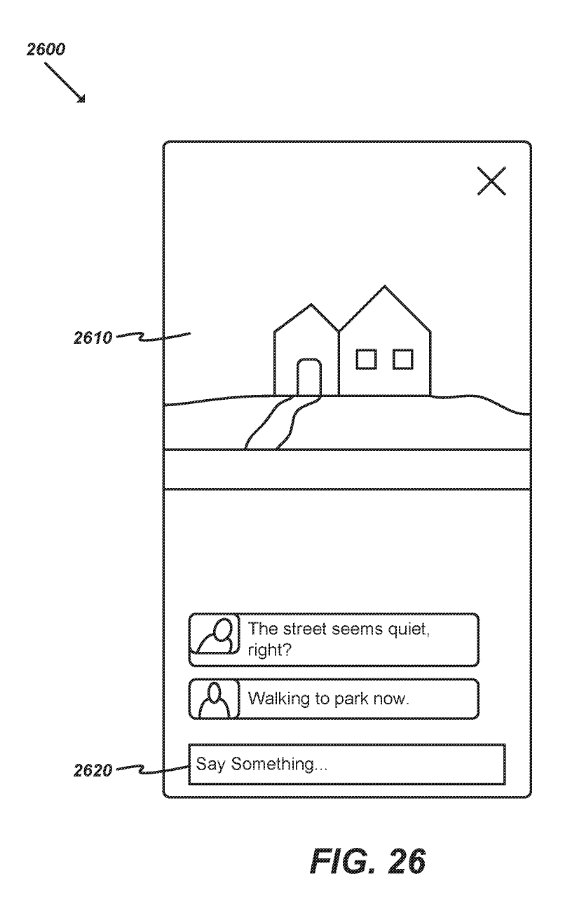

FIG. 26 illustrates an exemplary GUI 2600 that provides streaming surveillance between a responder and a requester. Such a GUI may be invoked, for instance, when a selected responder indicates that the responder is available (e.g., for a two-way session), when the responder selects a capture or start session option (e.g., for a recorded media session), and/or based on other appropriate criteria. As shown, this GUI may include a media display area 2610 and a communication interface 2620.

The media display area 2610 may allow a requester to view streaming content captured by the responder. The responder may be provided with a similar GUI.

The communication interface 2620 in this example, allows two-way text-based communication between the requester and the responder. In this way, the requester may ask for additional information, different perspective views, different zoom level, etc. For recorded sessions, the communication interface may be modified or eliminated. For instance, in some embodiments a responder may be able to enter information regarding the session. Some embodiments maFor recorded sessions, the communication interface may be modified or eliminated. For instance, in some embodiments a responder may be able to enter information regarding the session. Some embodiments may further allow for information to be provided via multimedia (e.g., by recording audio associated with a session).

One of ordinary skill in the art will recognize that the GUIs described above may be implemented in various different ways without departing from the scope of the disclosure. For instance, the various GUI elements may be arranged in different ways, some listed elements may be omitted, and/or some additional elements may be included. In addition, various additional GUIs and/or GUI elements may be invoked and/or eliminated depending on various appropriate criteria (e.g., user selection or preference, default settings, device type or attributes, etc.).

Some other types of GUIs that may be provided by some embodiments include confirmation screens, login or other authentication interfaces, payment and/or billing interfaces, feedback interfaces, and/or media selection or playback interfaces.

### V. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

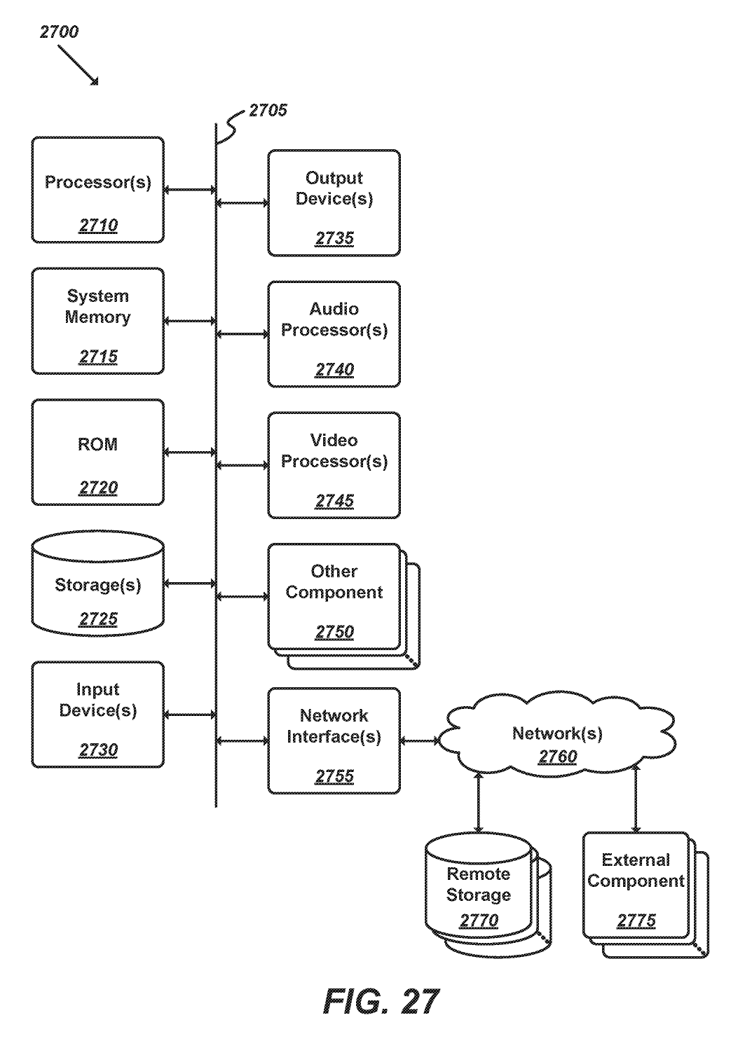

FIG. 27 illustrates a schematic block diagram of an exemplary computer system 2700 used to implement some embodiments. For example, the system described above in reference to FIG. 1 and/or the device described above in reference to FIG. 2 may be at least partially implemented using computer system 2700. As another example, the processes and algorithms described in reference to FIGS. 3-15 may be at least partially implemented using sets of instructions that are executed using computer system 2700.

Computer system 2700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 2700 may include at least one communication bus 2705, one or more processors 2710, a system memory 2715, a read-only memory (ROM) 2720, permanent storage devices 2725, input devices 2730, output devices 2735, audio processors 2740, video processors 2745, various other components 2750, and one or more network interfaces 2755.

Bus 2705 represents all communication pathways among the elements of computer system 2700. Such pathways may include wired, wireless, optical, and/or other appropriate communication pathways. For example, input devices 2730 and/or output devices 2735 may be coupled to the system 2700 using a wireless connection protocol or system.

The processor 2710 may, in order to execute the processes of some embodiments, retrieve instructions to execute and/or data to process from components such as system memory 2715, ROM 2720, and permanent storage device 2725. Such instructions and data may be passed over bus 2705.

System memory 2715 may be a volatile read-and-write memory, such as a random access memory (RAM). The system memory may store some of the instructions and data that the processor uses at runtime. The sets of instructions and/or data used to implement some embodiments may be stored in the system memory 2715, the permanent storage device 2725, and/or the read-only memory 2720. ROM 2720 may store static data and instructions that may be used by processor 2710 and/or other elements of the computer system.

Permanent storage device 2725 may be a read-and-write memory device. The permanent storage device may be a non-volatile memory unit that stores instructions and data even when computer system 2700 is off or unpowered. Computer system 2700 may use a removable storage device and/or a remote storage device as the permanent storage device.

Input devices 2730 may enable a user to communicate information to the computer system and/or manipulate various operations of the system. The input devices may include keyboards, cursor control devices, audio input devices and/or video input devices. Output devices 2735 may include printers, displays, audio devices, etc. Some or all of the input and/or output devices may be wirelessly or optically connected to the computer system 2700.

Audio processor 2740 may process and/or generate audio data and/or instructions. The audio processor may be able to receive audio data from an input device 2730 such as a microphone. The audio processor 2740 may be able to provide audio data to output devices 2740 such as a set of speakers. The audio data may include digital information and/or analog signals. The audio processor 2740 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 2745 (or graphics processing unit) may process and/or generate video data and/or instructions. The video processor may be able to receive video data from an input device 2730 such as a camera. The video processor 2745 may be able to provide video data to an output device 2740 such as a display. The video data may include digital information and/or analog signals. The video processor 2745 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video, such as the GUIs described above in reference to FIGS. 17-26.

Other components 2750 may perform various other functions including providing storage, interfacing with external systems or components, etc.

Finally, as shown in FIG. 27, computer system 2700 may include one or more network interfaces 2755 that are able to connect to one or more networks 2760. For example, computer system 2700 may be coupled to a web server on the Internet such that a web browser executing on computer system 2700 may interact with the web server as a user interacts with an interface that operates in the web browser. Computer system 2700 may be able to access one or more remote storages 2770 and one or more external components 2775 through the network interface 2755 and network 2760. The network interface(s) 2755 may include one or more application programming interfaces (APIs) that may allow the computer system 2700 to access remote systems and/or storages and also may allow remote systems and/or storages to access computer system 2700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 2700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. A distributed surveillance system comprising:
a plurality of requester devices, each requester device comprising at least one media presentation element;
a plurality of responder devices, each responder device comprising at least one media capture element that is able to capture media content; and
a server that is able to communicate among the plurality of requester devices and the plurality of responder devices.

2. The distributed surveillance system of claim 1, wherein the at least one media capture element comprises a camera.

3. The distributed surveillance system of claim 1, wherein at least one requester device and at least one responder device is a smartphone.

4. The distributed surveillance system of claim 1, wherein a particular responder device is designated as a selected device such that media captured by the particular responder device is received at the server.

5. The distributed surveillance system of claim 1, wherein a particular requester device is designated as a requesting device such that the captured media is sent to the particular requester device from the server.

6. The distributed surveillance system of claim 1, wherein the server is able to receive a request from at least one requester device, the request comprising a location, a type, and a rate.

7. The distributed surveillance system of claim 6, wherein the server is able to send the request to at least one responder device.

8. A method of providing surveillance for a requester, the method comprising:
receiving a request for surveillance from the requester;
publishing the request to at least one responder;
receiving at least one acceptance from the at least one responder;
sending a list of acceptances to the requester;
receiving a selection of a selected responder from among the at least one responder;
assigning the request to the selected responder; and
receiving multimedia from the selected responder.

9. The method of claim 8 further comprising sending the received multimedia to the requester.

10. The method of claim 9 further comprising providing a two-way communication channel between the requester and the selected responder while receiving multimedia from the selected responder and sending the received multimedia to the requester.

11. The method of claim 8, wherein the request comprises one of a real estate evaluation, a vehicle evaluation, and personal surveillance.

12. The method of claim 8, wherein the request comprises a location and a rate.

13. The method of claim 8, wherein the at least one responder is identified at least partly based on a location of the at least one responder and a location of the request.

14. The method of claim 8, wherein the multimedia comprises video.

15. A user device that allows surveillance within a distributed system, the user device comprising:
a processor for executing sets of instructions; and
a memory that stores the sets of instructions, wherein the sets of instructions comprise:
generating a surveillance request;
sending the surveillance request to a server;
receiving at least one response to the surveillance request;
receiving a selection of a responder from among a set of responders associated with the at least one response; and
receiving, from the selected responder, captured media at the user device.

16. The user device of claim 15, wherein the surveillance request comprises a location, a rate, and a type.

17. The user device of claim 16 further comprising sending the surveillance request to a set of responder devices.

18. The user device of claim 17, wherein the set of responder devices includes devices associated with responders located within a threshold distance of the location.

19. The user device of claim 15, wherein the captured media comprises video.

20. The user device of claim 15 further comprising sending feedback to the selected responder while receiving captured media at the user device.
